(19) United States
(12) Patent Application Publication
(10) Pub. No.: US 2013/0018887 A1
(43) Pub. Date: Jan. 17, 2013

(54) Image Viewer System

(71) Applicant: Octavio Cesar Silva, (US)

(72) Inventor: Octavio Cesar Silva, (US)

(21) Appl. No.: 13/180,408

(22) Filed: Jul. 11, 2011

(51) Int. Cl. G06F 17/30

(52) U.S. Cl. 707/740; 707/E17.005; 707/E17.019

(57) ABSTRACT

The invention, the Image Viewer system, represents a new way to store and access medical images such as scans and X-rays. The invention is comprised of the web portal design, including the web browser layout, and the software application. A patient's medical images, created during an imaging session, are stored at a central location, a web portal, by medical personnel who catalog and code the images using the software application or a web browser. The images stored at the portal can be accessed by any networked device with a web browser or the software application from any connection to the Internet. The connection to the Internet can be wired or wireless, such as WiFi or cellular. Networked devices include PCs, tablets, laptops and smart phones. Physicians with a network device can retrieve images and enter data in the web portal, including diagnoses and personal information. Patients with a networked device can access the portal to download images or to enter their personal profile.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The invention, the Image Viewer system, relates to a new way of storing, characterizing and accessing medical images from a web portal, such as X-rays and MRIs, by medical personnel and patients. The invention can be classified in the fields of Internet networking, data processing and data warehousing. Presently, patients are given CDs containing any images from a medical scanning session that they have undergone. The CD, which also contains a software application to view images, is inserted in a computer and the patient, using the software application, can view images when desired. Similarly, doctors can access the CD or a hospital Intranet to view the medical images using personal computers or laptops. The invention provides a unique way to store and catalog medical images at a central location, the web portal, from which they are accessed by medical personnel and patients via the Internet or an intranet. This invention circumvents the need to issue CDS and extends medical viewing capability by any networked device, including smartphones, from any connection to the Internet. The networked device uses a web browser or a software application to enter information or to access images without the need of a CD.

### BRIEF SUMMARY OF THE INVENTION

The Image Viewer is a system designed to store and view medical images, such as MRI scans and X-rays, and pertinent patient and physician data. The images and data are stored centrally at a web portal and can be accessed by any networked device with access to the Internet. The invention is comprised of the design of the web portal, including the layout of the web browser, and the network device software application. The images are entered and cataloged in a web portal by medical personnel. Physicians access the portal using a network device to view and download images or to enter information such as patient diagnoses. The network device can use a web browser or the software application to access the web portal. The layout viewed in the web browser and the software application have the same functions and buttons. Network devices can access the portal via standard interfaces to the Internet, including Ethernet, WiFi, WiMax and 3G and 4 G cellular networks, using a web browser or the software application. Network devices include desktops, laptops, tablets and smart phones such as the iPhone and Android phones.

### DRAWING DESCRIPTION

FIG. 1 shows the design layout of the portal home page or the software application front page.

FIG. 2 shows the layout of the portal page or software application page used to enter information by medical personnel.

FIG. 3 shows the layout of the portal or software application page used to enter the data of new patients. This page, accessed from the page in FIG. 2, is used to enter patient data by medical personnel.

FIG. 4 shows the layout of the patient list accessed from the patient index in FIG. 2.

FIG. 5 shows the layout of the physician list accessed from the physician index in FIG. 2.

FIG. 6 shows the layout of the patient list accessed by clicking on a physician name in FIG. 5.

FIG. 7 shows the portal page or software application page used by physicians to register themselves at the web portal. It requests all the pertinent information from the physicians.

FIG. 8 shows the layout of the physician page. This is the page used by physicians to access patient information. Patient information can be accessed by with the aid of an index. This page is also used to update a physicians profile and to change the password and username.

FIG. 9 shown the layout of the patient list accessed from the physician page index.

FIG. 10 shows the layout of the patient page used by physicians to access patient data and images. It is used by physicians to enter and edit diagnoses.

FIG. 11 is entered from the “Images” button in the patient page shown in FIG. 10. It shows a patient's images for a given session indexed by code. The images can be downloaded from this page.

FIG. 12 is entered from the “Diagnosis Entry” in FIG. 10. It is used to enter the diagnosis for a given imaging session. All the information pertinent for a given diagnosis is entered. This page is also used by the physician to authorize patients to see the images and diagnosis.

FIG. 13 is entered from the “Edit Diagnosis” button in FIG. 10. After the “Edit Diagnosis” button is clicked, a list of diagnosis images codes appears as links. By clicking on a link, FIG. 9 is displayed. This page is used to revise a diagnosis previously entered.

FIG. 14 shows the layout of the portal or software application page used by patients to register themselves at the web portal. This page requests all the pertinent information from patients so that they can access the web portal and their images.

FIG. 15 shows the layout of the portal of software application page where patients can see their data. Patients can access their diagnosis page from this page as well as see their profile and change username and password.

FIG. 16 shows the layout of the portal or software application page where patients can see and download their images.

FIG. 17 shows the architecture of the overall system with network devices connected to the Internet and the web portal.

### SYSTEM FUNCTIONS

After an image is taken, a medical technician uploads the image to the web portal and indexes it by a unique code and the date of the imaging session. He enters patient data, including name, age, domicile, phone number, e-mail address, imaging facility, description of the condition, date, time and consulting physicians. He also uploads consulting physician data, including name, license, domicile, phone number, e-mail address and medical group. The system stores the properties of the image file, including image name, size, date and time. The system notifies the physicians when the images are available for viewing and diagnosis. After viewing the image, the consulting physician enters the diagnosis in the system. He then consults with the patient and sends a message to the portal to allow viewing of the image by the patient.

The patient can then access the images from any network device with access to the Internet.

### System Design

### 7.1 Portal Design

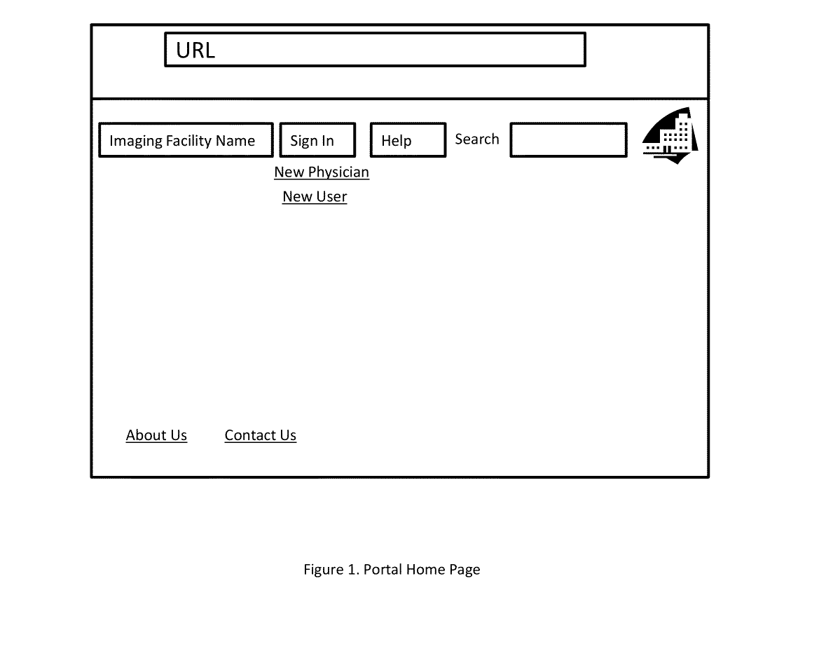

The portal or software application front page is designed as shown in FIG. 1. To access the portal, the URL is entered in a web browser or the software application. This sign in page is displayed to all users. The basic features of the portal are:
a. The name of the Imaging facility. When clicked, it takes user to portal home page or the software application front page. This is displayed in all of the pages as shown in the figures.
b. The imaging facility logo. This is displayed in all of the pages as shown in the figures.
c. “About Us” link. It provides information about the imaging facility. This is always displayed in all of the pages as shown in the figures.
d. A “New Physician” link to register new physicians.
e. A “New User” link to register new patients.
f. A “Sign In” button for registered physicians, patients and medical personnel.
g. “Contact Us” link. When clicked, it displays the imaging facility contact options. This is displayed in all of the pages as shown in the figures.
h. A “Search” field to search data in the website. This is displayed in all of the pages as shown in the figures.
i. A “Help” button. It provides information on site navigation, the fields, buttons, etc. This is displayed in all of the pages as shown in the figures.

### 7.2 Imaging Facility Data Entry

Each imaging facility is allocated a web portal. Personnel at an imaging facility are registered in the web portal by IT personnel and can access it from the Intranet or Internet upon entering a username and password in a web browser or the software application. Personnel click on the portal link in the home page of the imaging facility or hospital Intranet site. They can also type the URL on a web browser or the software application and enter the site upon entering a username and password. The web browser layout and the software application have the same functions and buttons. Personnel are recognized automatically by the system, based on username and password, which displays the appropriate pages.

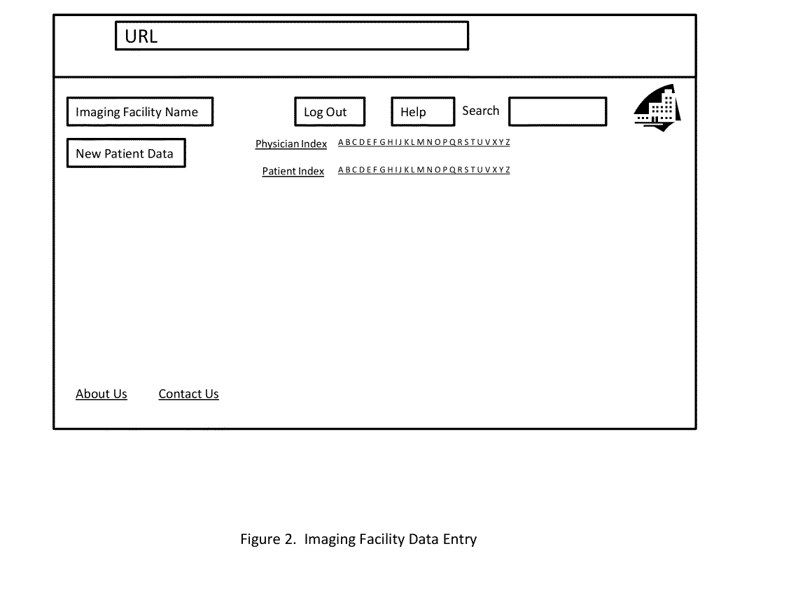

Personnel are taken to the data entry page, shown in FIG. 2, after signing in.

The following buttons are displayed in the data entry page:
a. “New Patient Data” button. If clicked, the “New Patient Data” entry form is displayed. See below for description, paragraph [00028]
b. “Patient Index”. See below for description, paragraph[00029]
c. “Physician Index”. See below for description, paragraph[00030]
d. “Search” field. This is a search engine. Physicians and patients names can be looked up.
e. “Log Out” button. It is displayed in all personnel pages.

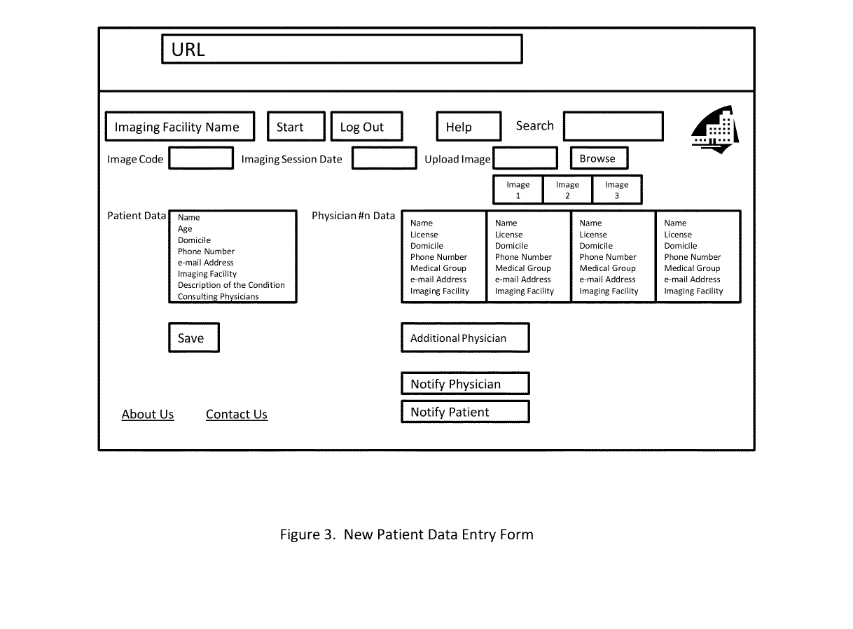

The following fields and buttons are in the “New Patient Data” data entry form as shown in FIG. 3:
a. “Image Code” field. The code for the set of images taken for a given imaging session is entered.
b. “Imaging Session Date” field. The date for the imaging session is entered.
c. “Upload Image” field with a “Browse” button to search for the image location. An entry is made for every image. The image properties are entered, namely image name, size, code and date. Each image that is entered in displayed as a small icon.
d. “Patient Data” fields. The following fields are displayed under the “Patient Data” field
   i. Name. Once a name is created, it is put in the database.
   ii. Age
   iii. Domicile
   iv. Phone Number
   v. e-mail address
   vi. Imaging facility
   vii. Description of the condition
   viii. Consulting physicians
e. “Physician # n Data” field. Four sets are displayed at a time. Each set contains the information for every physician in the patient's case.
   i. Name. Once a name is created, it is put in the database.
   ii. License
   iii. Domicile
   iv. Phone Number
   v. Medical Group
   vi. e-mail address
f. “Save” button. If clicked, it saves the entered data in the “Patient Data” and “Physician #n Data” fields.
g. “Additional Physician” button. If clicked, it displays the next four sets to enter additional physician data.
h. “Start” button. If clicked, it takes personnel to the start page (the data entry page, FIG. 2).
i. “Notify Patient”. It notifies patients after data has been entered and creates temporary user names and passwords.
j. “Notify Physician”. It notifies physicians after data has been entered and creates temporary user names and passwords.

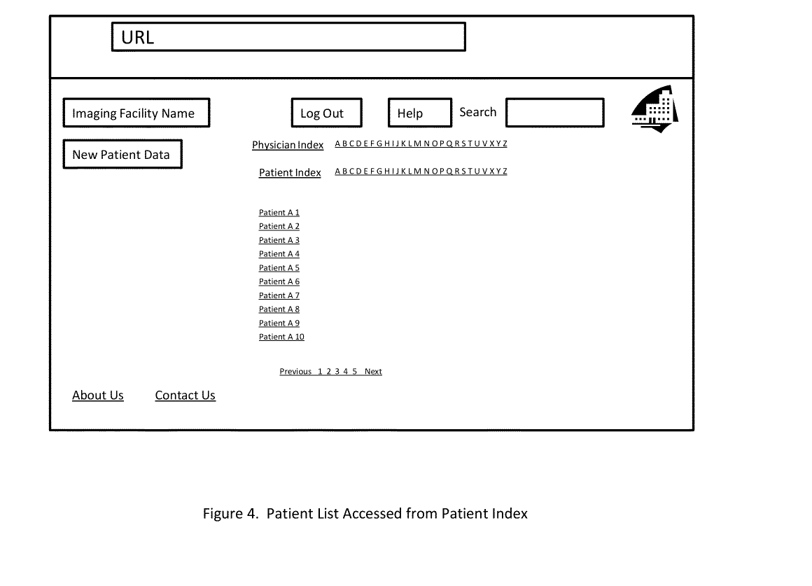

“Patient Index”, listed in paragraph [00027].b. The letters of the alphabet are displayed as links. When a letter is clicked, a list of patients whose data has already been entered is displayed as links (the name of the patient) under that letter as shown n FIG. 4. At the bottom of the page, the number of pages for that alphabet letter is displayed. The numbers are displayed as links. Clicking on a number takes personnel to that portion of the list. The numbers are displayed in sets of five. A “Next” button is displayed on the right hand side to take the personnel to the next set. A “Previous” button is displayed on the left side to take personnel to the previous set. If a link for a patient is clicked, the system is taken to the “New Patient Data” entry form (described in paragraph [00028]) for that specific patient.

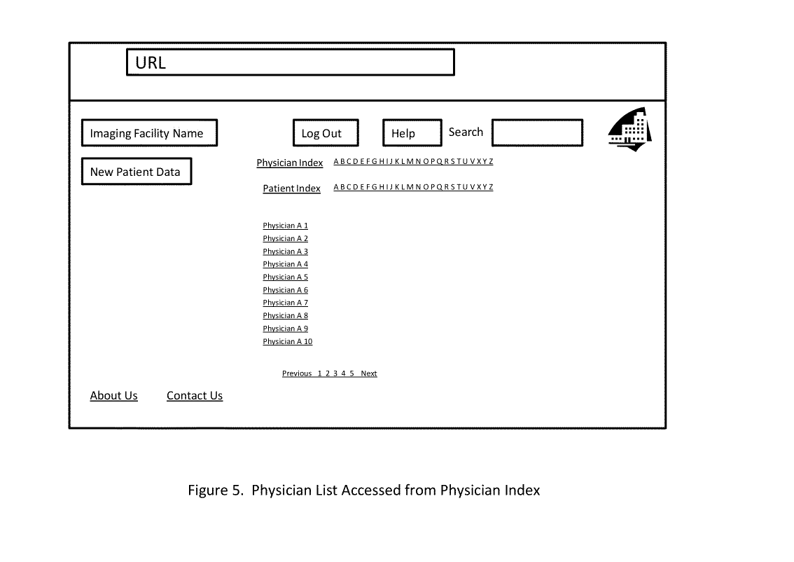

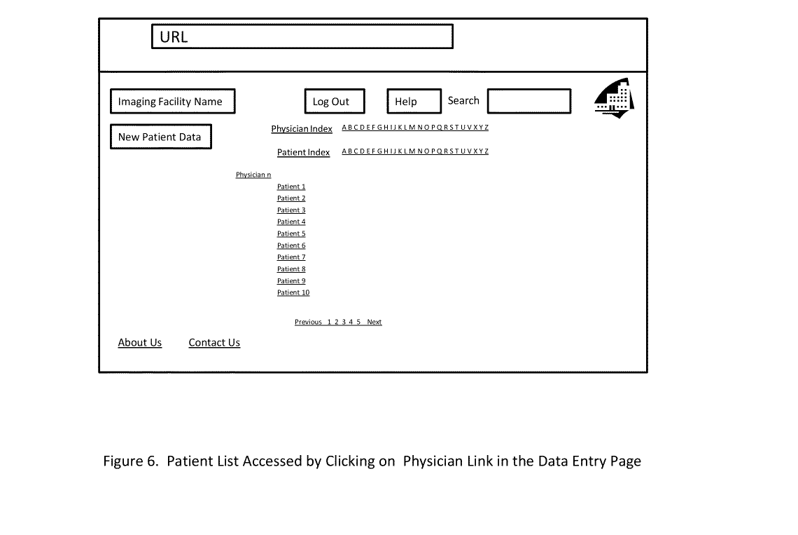

“Physician Index”, listed in paragraph[00027].c. The letters of the alphabet are displayed as links. When a letter is clicked, a list of physician names as links is displayed under that letter as shown in FIG. 5. This list is for physicians whose data has already been entered. At the bottom of the page, the number of pages for that alphabet letter is displayed. The numbers are displayed as links. Clicking on a number takes the personnel to that portion of the list. The numbers are displayed in sets of five. A “Next” button is displayed on the right hand side to take personnel to the next set. A “Previous” button is displayed on the left side to take personnel to the previous set. If a physician name link is clicked, the names of the patients for that physician are displayed as links as shown in FIG. 6. If a link for a patient is clicked, the system is taken to the “New Patient Data”entry form (described in paragraph [00028]) for that specific patient.

The search field can also be used to find a physician or patient whose data has already been entered. The patient or physician name is entered in the “Search” field and the results are displayed as links, the name of the patient or physician. In the case of physicians, when a physician link is clicked, a list of his patients is displayed as links. If a patient link is clicked, the “New Patient Data” entry form page is displayed.

### 7.3 Physician Data Entry

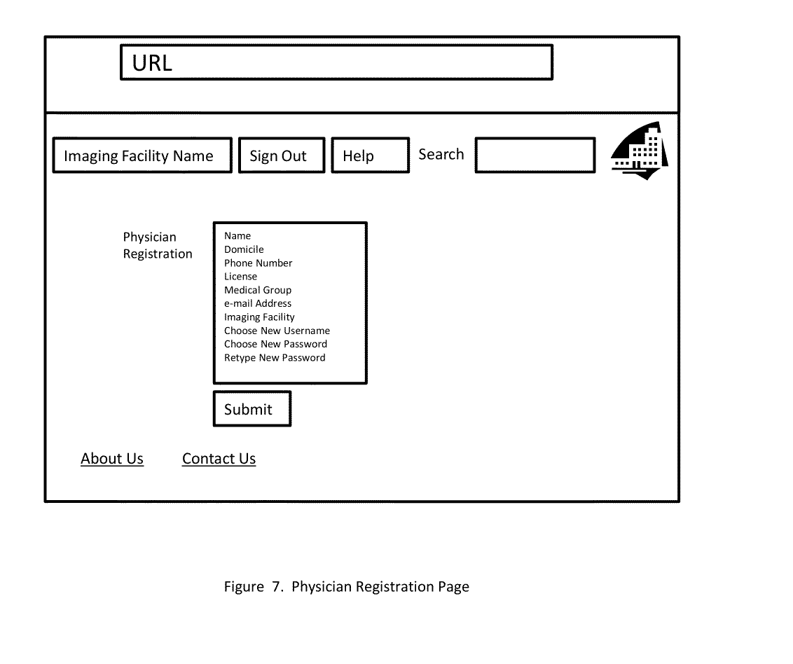

Physicians log on to the web portal to enter data using a web browser or the software application. The buttons and fields are the same for the web browser and the software application. Physicians are recognized automatically by the system, based on username and password, which displays the appropriate pages in the web browser or the software application. Initially, physicians register with the imaging facility web portal upon receiving a username and password. Physicians enter the portal URL in a web browser or software application. Then they click on the “New Physician” link (FIG. 2), enter the username and password and click on the “Submit” button. If accepted, the physician is taken to the “Registration” page. If rejected, the system notifies the physician. The “Registration” page has the following fields (FIG. 7):
a. Name
b. License
c. Domicile
d. Phone Number
e. Medical Group
f. e-mail address
g. Choose New Username
h. Choose New Password
i. Retype New Password
j. Choose Challenge Questions

The buttons in the “Registration” page are:
a. “Submit”button. This button is clicked when all the fields in the “Registration” page are entered.
b. “Sign Out” button. This button signs out the physician. It is displayed in all of the pages.

The system notifies the physician if a field is missing or if the password was entered incorrectly, displaying the “Registration” page and its fields. The system indicates the incomplete or erroneous field. The system also rejects a user if it does not recognize his ID. Upon registering, the system displays:
a. “Do you want to continue to the Physician Page?”
b. Two buttons are displayed: “Yes” and “No”
c. If the user clicks “No”, he is taken out of system to the portal Home page or the software application front page.
d. If the user clicks “Yes”, he is taken to the Physician Page.

The physician is also taken to the Physician Page upon entering the user name and password after clicking on the “Sign In” button in the Home or front page if he has registered previously.

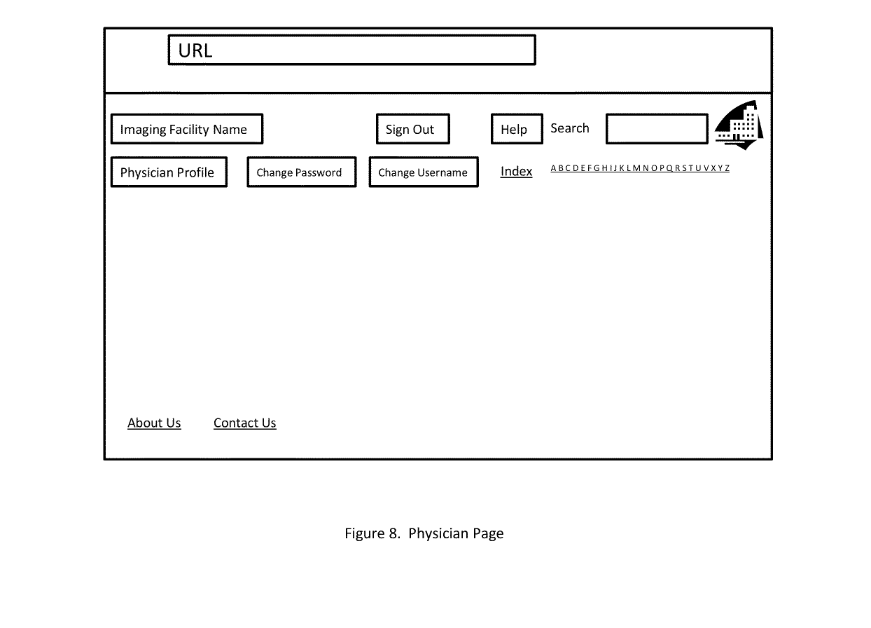

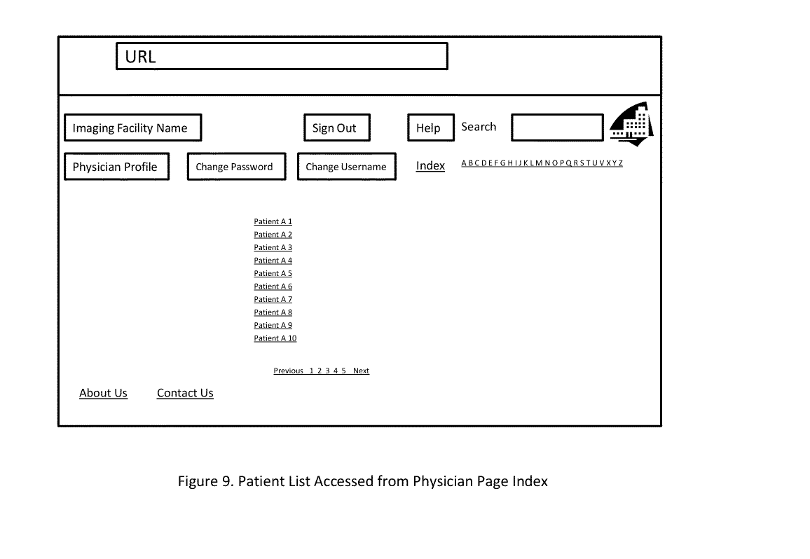

The Physician page has the following fields and buttons as shown in FIG. 8:
a. “Search” Button. The patient name is entered and the button is clicked. If found, the name of the patient is displayed as a link. If the patient is not found, the system displays “Patient Not Found”. Otherwise, the physician clicks on the patient name and is taken to the Patient Page (described in paragraph [00037] below).
b. “Index”. The letters of the alphabet are displayed as links. When a letter is clicked, a list of patients names as links is displayed under that letter as shown in FIG. 9. At the bottom of the page, the number of patient lists for that alphabet letter is displayed. The numbers are displayed as links. Clicking on a number takes the physician to that portion of the list. The numbers are displayed in sets of five. A “Next” button is displayed on the right hand side to take the physician to the next set. A “Previous” button is displayed on the left side to take the physician to the previous set. To access a Patient Page (described in paragraph [00037] below), the name is clicked.
c. “Physician Profile” button. If clicked, the System displays the profile data entered by the physician. This page has the following buttons:
   i. “Edit”. If clicked, a new page is displayed with entry fields below each field to update it. In this page the following buttons are displayed:
      1.“Save”. If clicked, the edited fields are updated.
d. “Change Password”. If clicked, the following fields and button are displayed:
   i. “Old Password”. The user enters his old password.
   ii. “New Password”. The user enters his new password.
   iii. “Retype New Password”. The user retypes his new password.
   iv. A “Submit” button. If clicked the entered information is updated
e. “Change Username”. If clicked, the following fields and button are displayed:
   i. “Old Username”. The user enters his old username.
   ii. “New Password”. The user enters his new password.
   iii. A“Submit” button. If clicked the entered information is update
f. “Sign Out” button. This button signs out the physician and takes him to the portal main page.

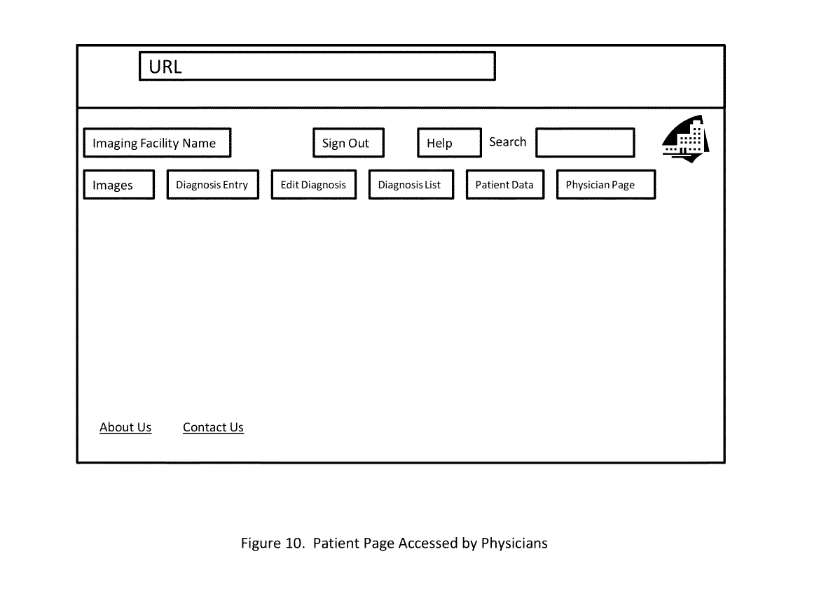

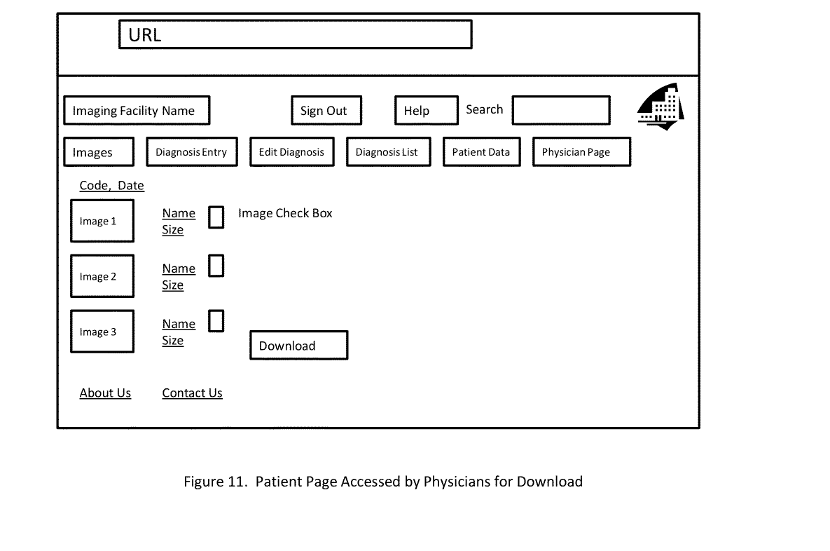

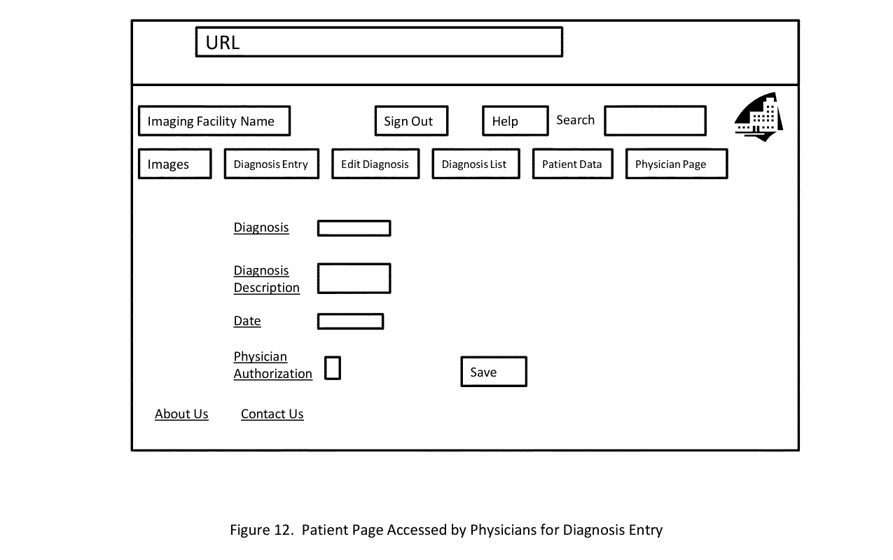

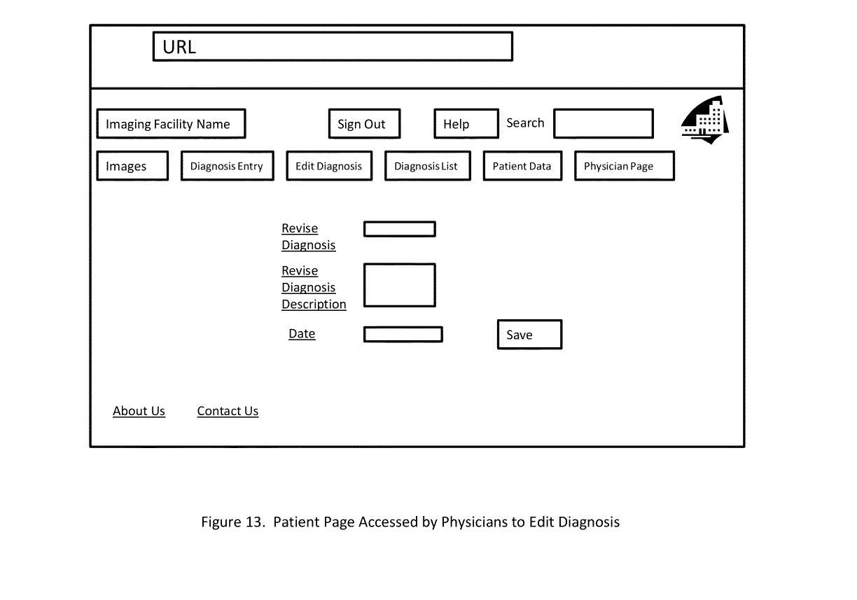

The Patient Page accessed from the index listed in paragraph [00036].b has the following buttons as shown in FIG. 10:
a. “Images” button. If clicked, a list of patient's images indexed by code and date is displayed as links. Each set of images taken during an imaging session is indexed by a unique code. If a link is clicked, the following are displayed as shown in FIG. 11:
   i. The patients images for that code, including their name, size and date.
   ii. A select box next to each image. A box is checked to select the image
   iii. A “Download” button. If clicked, the selected images are downloaded to the physician. The page remains after downloading the images.
   iv. If an image is clicked, an enlarged version is displayed in a new window.
b. “Diagnosis Entry”. If clicked, a list of patient's images indexed by code and date is displayed as links. Each set of images taken during an imaging session is indexed by a unique code. If a link is clicked the following fields and buttons are displayed as shown in FIG. 12:
   i. “Diagnosis” field. The diagnosis classification is entered along with its corresponding code for that set of images.
   ii. “Description” field. Description of the condition is entered.
   iii. “Date” field. The date the diagnosis was entered is entered.
   iv. “Save” button. If clicked, it saves the entered data.
   v. “Physician Authorization” check box. If checked, the physician authorizes patient to view images for this diagnosis.
c. “Edit Diagnosis” button. If clicked, it lists all the diagnoses for that patient as links along with the image code. If link is clicked, the following fields and buttons are displayed as shown in FIG. 13:
   i. “Revise Diagnosis” field. The revision of the diagnosis is entered.
   ii. “Revise Description” field. The revision of the condition is entered.
   iii. “Date” field. The date of diagnosis edit is entered.
   iv. “Save” button. If clicked, it saves the entered data.
d. “Diagnosis List” button. If clicked, it lists all the diagnoses for that patient as links along with the image code. If a link is clicked, the description of that diagnosis along with history (revisions) and image code is displayed.
e. “Patient Data”. If clicked, it displays the same patient data entered in the imaging facility
f. “Physician Page”. Takes physician to Physician Page.
g. “Sign Out” button. This button signs out the physician and takes him to the portal main page.

7.4 Patient Web Portal Access

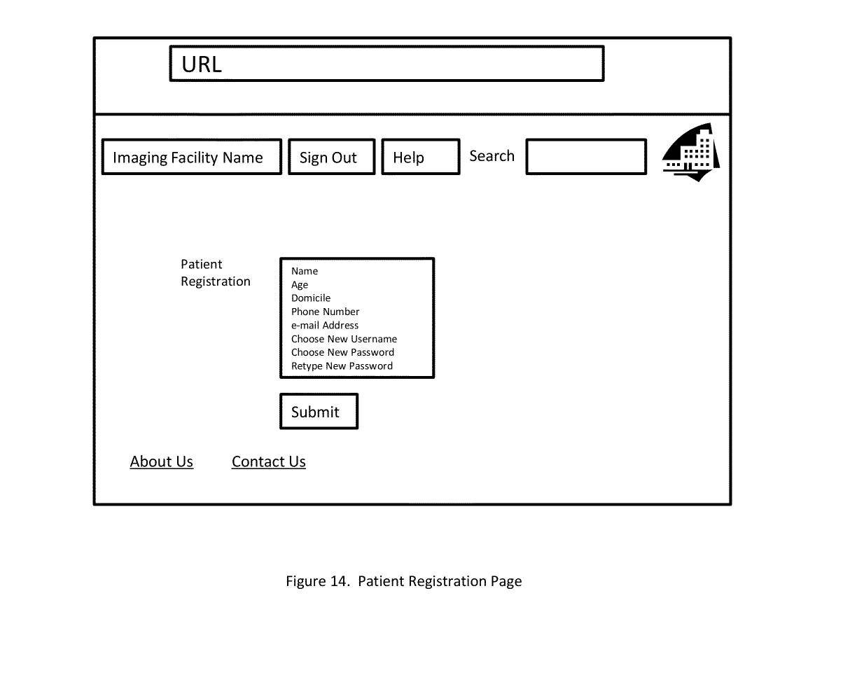

Patients log on to the web portal using a web browser or the software application to access images. The web browser and software application pages have the same fields and buttons. Initially, patients register with the imaging facility web portal upon receiving a username and password. Patients are recognized automatically by the system, based on username and password, which displays the appropriate pages. Patients enter the portal URL in a web browser or software application. Then, they click on the “New User” and enter the username and password and click on the “Submit” button. If accepted, the patient is taken to the “Registration” page. If rejected, the system notifies so to the patient. The “Registration” page has the following fields as shown in FIG. 14:
a. Name
b. Age
c. Domicile
d. Phone Number
e. e-mail address
f. Choose Username
g. Choose New Password
h. Retype New Password

The buttons in the “Registration” page are:
a. “Submit”. This button is clicked when all the fields in the “Registration” page are entered.
b. “Sign Out”. This button signs out the patient and takes him to the portal main page.

The system notifies the patient if a field is missing or if the password was entered incorrectly, displaying the “Registration” page and its fields. The system indicates the incomplete or erroneous field. The system also rejects a patient if it does not recognize his password. Upon registering, the system displays:
a. “Do you want to continue to the User Page?”
b. Two buttons are displayed: “Yes” and “No”
c. If the patient clicks “No”, he is taken out of system to the portal Home page.
d. If the patient clicks “Yes”, he is taken to the User Page.

The patient is also taken to the User Page upon entering the user name and password after clicking on the “Sign In” button in the Home page or software application front page if he has registered previously. The fields and buttons in the “Sign In” page are:
a. “Username”. The user enters his user name.
b. “Password”. The user enters his password.
c. “Submit”. It submits username and password.

Upon validation, the user is taken to the User Page. If the patient is not recognized, the System displays in the Sign In page: “Patient Not Recognized”.

In the User Page, the patient can view or download images.

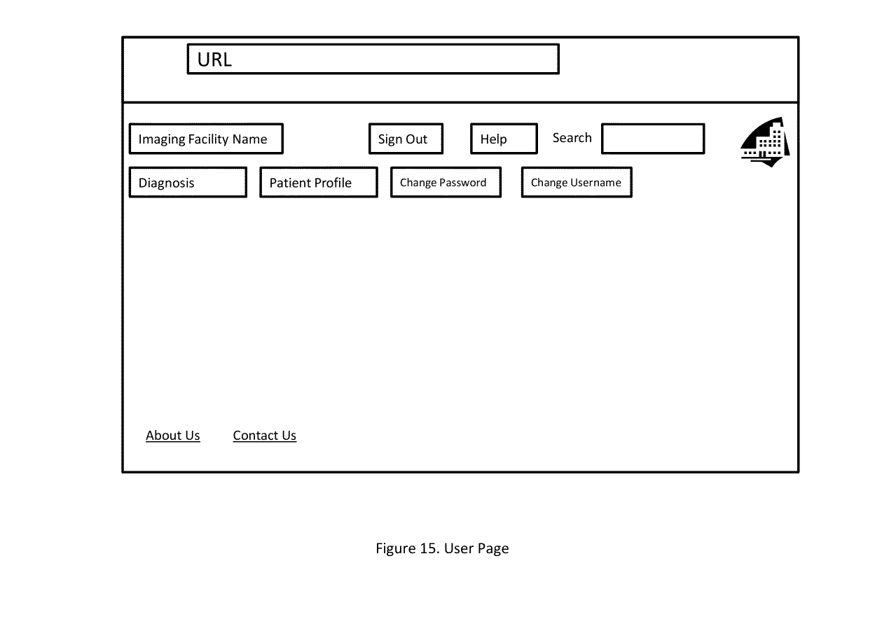

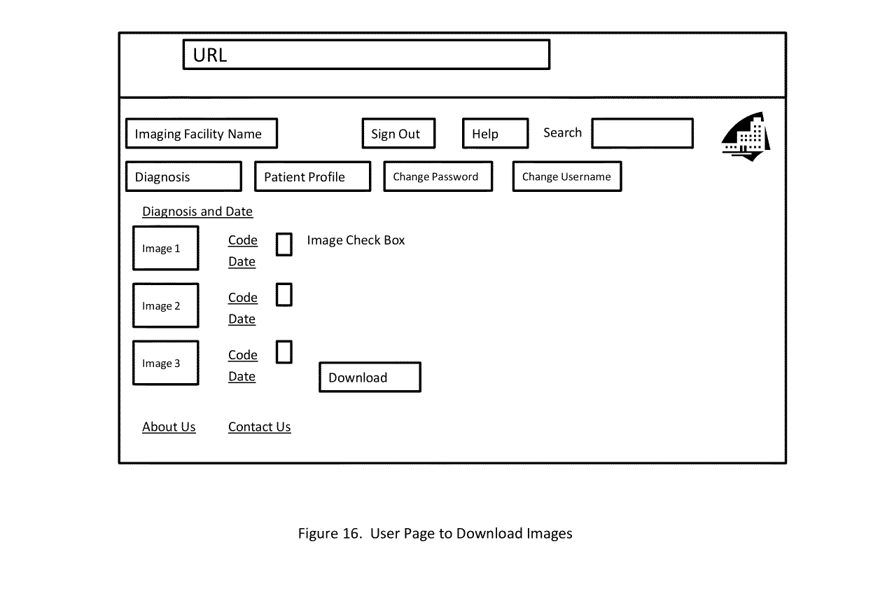

The User Page has the following buttons as shown in FIG. 15:
a. “Diagnosis” button. If clicked, the System displays the diagnoses indexed by code and date below the button. Each diagnosis is a link. If a link is clicked, the system takes the user to that diagnosis page as shown in FIG. 16. The page displays the following:
   i. The diagnosis and the date
   ii. The images for that diagnosis index by code and date
   iii. A select box next to each image. A box is checked to select the image
   iv. A “Download”button. If clicked, the selected images are downloaded to the user. The page remains after downloading the images
   v. If an image is clicked, an enlarged version is displayed in a new window
b. “Patient Profile” button. If clicked, the System displays the data entered by the patient. This page has the following buttons:
   i. “Edit”. If clicked, a new page is displayed with entry fields below each field to update it. In this page the following buttons are displayed:

1.“Save”. If clicked, the edited fields are updated.
c. “Change Password”. If clicked, the following fields and button are displayed:
   i. “Old Password”. The user enters his old password.
   ii. “New Password”. The user enters his new password.
   iii. “Retype New Password”. The user retypes his new password.
   iv. “Submit” button. If clicked the entered information is updated
d. “Change Username”. If clicked, the following fields and button are displayed:
   i. “Old Username”. The user enters his old username.
   ii. “New Password”. The user enters his new password.
   iii. “Submit” button. If clicked the entered information is updated
e. “Sign Out” button. This button signs out the patient and takes him to the portal main page.

### Communications Links and Server Design

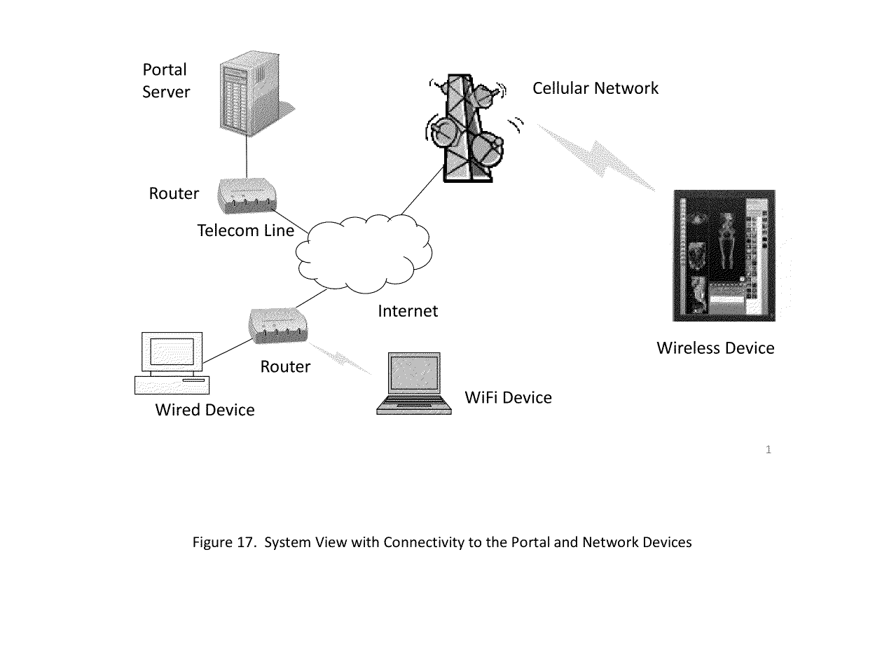

Any network device can access the web portal server through a connection to the Internet. Access to the Internet is via any standardized communications links as shown in FIG. 17. This figure shows the overall architecture of the system and how the network devices connect to the web portal. 3G and 4G cellular links access the Internet using the standardized 3GPP (3G), LTE and UMTS (4G) Internet access architecture. The wireless devices negotiate access to base stations through cellular protocols and the cellular system core network interfaces to the Internet. Similarly, WiMax devices connect to a WiMax wireless station through wireless protocols, and, once the RF links are established, the WiMax core network architecture allows an interface to the Internet. Ethernet and WiFi connections to the Internet are through their standardized protocols as well. Portable and fixed devices are built with the necessary software and hardware to support these communications standards.

The portal connects to the Internet via standard telecommunications networks and protocols, such as the Pleosynchronous Digital Hierarchy (PDH) architecture. The portal architecture is built upon off-the-shelf server technology such as Hypertext Preprocessor (PHP) and LAMP.

1. A system for cataloging, storing, and accessing medical images comprised of:
a. A web portal consisting of servers with a broadband connection to the Internet and the Intranet of the imaging facility.
b. A software program residing in the web portal in claim La that enables the storing of, the cataloging of and the access to medical images from said web portal.
c. The software program in claim 1.b, containing web pages that provide an interface to web browsers to allow access to the system functions for medical personnel, physicians and patients.
d. A software application residing in a computing device that allows medical personnel to store and catalog images in the web portal in claim 1.a.
e. A software application residing in a computing device for physicians to register with, update information in and download medical images from the web portal in claim 1.a.
f. A software application residing in a computing device for users to register with, update information in and download medical images from the web portal in claim 1.a.
g. A process for cataloging, storing and accessing medical images.
